(19) United States
(12) Patent Application Publication
(10) Pub. No.: US 2018/0155959 A1
(43) Pub. Date: Jun. 7, 2018

(54) DEADBOLT LATCH ASSEMBLY WITH LATCH SENSOR HAVING WIRELESS STATUS INDICATOR

(71) Applicant: HAMPTON PRODUCTS INTERNATIONAL CORPORATION, Foothill Ranch, CA (US)

(72) Inventors: James Hartung, Foothill Ranch, CA (US); Lucas J. Stanton, Stone Lake, WI (US)

(73) Assignee: HAMPTON PRODUCTS INTERNATIONAL CORPORATION, Foothill Ranch, CA (US)

(21) Appl. No.: 15/831,094

(22) Filed: Dec. 4, 2017

Related U.S. Application Data
(60) Provisional application No. 62/429,447, filed on Dec. 2, 2016.

(51) Int. Cl. E05B 17/22; G08B 5/36

(52) U.S. Cl. CPC E05B 17/22; E05B 2047/0069; G08B 5/36

(57) ABSTRACT

A door locking apparatus and system includes a locking assembly with a latch movable between an unlocked position and a locked position; a position detector configured to determine whether the latch is in the unlocked position or in the locked position and to generate a position signal having a first value when the latch is in the first position and a second value when the latch is in the second position; and a transmitter configured to receive the position signal and to transmit a wireless signal indicative of the value of the position signal. The wireless signal is receivable by a remote electronic device to allow for remote monitoring of the status of the locking assembly as either locked or unlocked depending on the value of the position signal indicated by the wireless signal.

### CROSS-REFERENCE TO RELATED APPLICATION

This application claims priority, under 35 U.S.C. § 119(e), from U.S. Provisional Application No. 62/429,447, filed Dec. 2, 2016, the disclosure of which is incorporated herein by reference in its entirety.

### FEDERALLY SPONSORED RESEARCH OR DEVELOPMENT

Not Applicable.

### FIELD OF THE ART

The present disclosure pertains to detection and monitoring of the locking status of a deadbolt lock, and related methods, and more particularly to the remote monitoring of the locking status of the deadbolt lock by electronic devices.

### BACKGROUND

Users of a standard/traditional key-operated single-cylinder mechanical deadbolt lock mounted on residential doors need to move within visual or physical contact proximity of the inside thumb-turn assembly of the deadbolt lock to determine if the deadbolt of the lock is extended into the strike plate assembly mounted on the door jamb. The position of the thumb-turn lever on the interior side of the lock typically provides a visual reference to the deadbolt being in the fully extended (“locked”) position, fully retracted (“unlocked”) position, or a position between the fully extended and fully retracted position. Moreover, even with visual confirmation of the thumb-turn lever in the fully extended position, the deadbolt may not be fully extended into the strike box of the strike plate assembly, such as when the door is slightly ajar. Further confirmation of the locked state requires the user to move closer to the deadbolt lock for a more certain visual confirmation or by physically attempting to move the door to determine if the deadbolt is indeed in the fully extended position and extended into the strike box.

### SUMMARY

The present disclosure relates to electronic monitoring of a deadbolt door lock, or a door lock functionally similar to a deadbolt. (For the purpose of this disclosure, the term “deadbolt lock” shall encompass any lock functionally similar or equivalent to a deadbolt.) Traditionally, visual verification of the locked state requires the user to be physically near the deadbolt lock to determine whether or not the door is locked. It requires the user to move closer to the deadbolt lock for a more certain visual confirmation, or to attempt physically to move the door to determine if the deadbolt is indeed in the fully extended position and extended into the strike box. Even just looking at the thumb turn of a deadbolt lock may not confirm that the deadbolt lock is fully locked.

Broadly, this disclosure relates to an electronic system for monitoring the real-time state of a deadbolt lock as to whether the deadbolt is in an unlocked or locked state. The system and method allow for remote monitoring of the deadbolt lock through an electronic device rather than by physically viewing the deadbolt lock.

In operation, a user can use an electronic device, such as a smart phone, tablet, personal computer, or security system to run program code or an application (“APP”) for interfacing with the deadbolt monitoring lock system. The deadbolt monitoring lock system can detect a state of the deadbolt assembly and transmit this information wirelessly to the electronic device of the user. In this way, the user does not need to be close enough to the deadbolt lock to be either to view the lock or to be in physical contact with it.

### BRIEF DESCRIPTION OF THE DRAWINGS

FIG. 1 shows a partial exploded view of an embodiment where a deadbolt latch assembly comprises a deadbolt lock and a receiver mount bracket.

FIGS. 2 and 3 show embodiments of an enclosure housing for a deadbolt lock monitoring system in accordance with this disclosure.

FIG. 4 shows an exterior of an exemplary embodiment of the enclosure housing of the deadbolt lock monitoring system.

FIG. 5 shows an embodiment of a deadbolt lock monitoring system mountable on a door.

FIG. 6 shows an exploded view of components of the deadbolt lock monitoring system.

FIG. 7 shows a sectional view of a latch assembly in an unlocked, or retracted, state.

FIG. 8 shows a sectional view of a latch assembly in a locked, or extended, state.

FIGS. 9A and 9B show perspective and plan views of the latch assembly in a fully extended state.

FIGS. 10A and 10B show perspective and plan views of the latch assembly in a fully retracted state.

FIGS. 11A and 11B show perspective and plan views of the deadbolt lock monitoring system in an assembled state.

### DETAILED DESCRIPTION

The detailed description set forth below in connection with the appended drawings is intended as a description of the presently preferred embodiments of the deadbolt lock monitoring system provided in accordance with aspects of the present components, assemblies, and method. It is not intended to represent the only forms in which the present components, assemblies, and method may be constructed or utilized. The description sets forth the features and the steps for constructing and using the embodiments of the present components, assemblies, and method in connection with the illustrated embodiments. It is to be understood, however, that the same or equivalent functions and structures may be accomplished by different embodiments that are also intended to be encompassed within the spirit and scope of the present disclosure. As denoted elsewhere herein, like element numbers are intended to indicate like or similar elements or features. Embodiments can relate to at least one of a magnetic sensor and a contact switch, a contact switch, and a magnetic sensor.

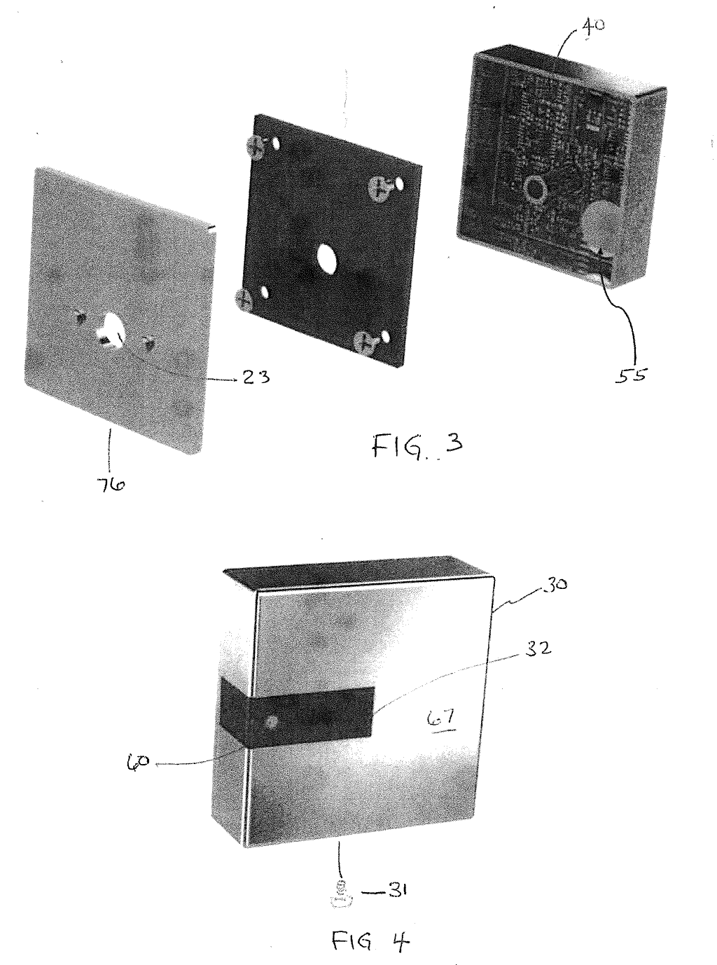

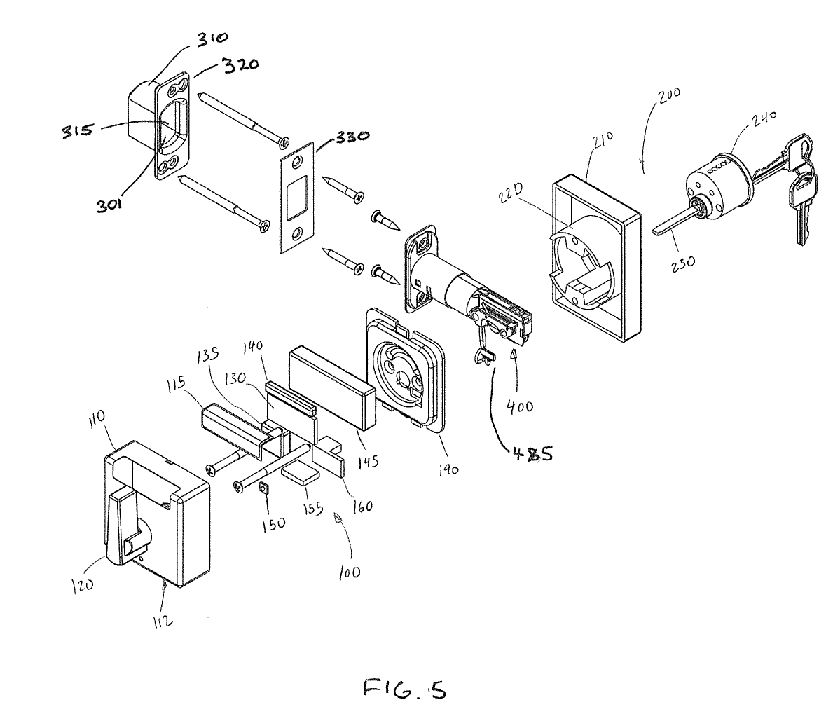

FIG. 1 illustrates an exemplary embodiment of components for a deadbolt lock monitoring system. FIG. 1 illustrates a partial exploded view of an embodiment where a deadbolt latch assembly 12 comprises a deadbolt 84 and a receiver mount bracket 15. A switch, advantageously a contact switch or a “micro” contact switch 20, can be positioned and coupled to the receiver mount bracket 15. One or more fasteners 24 may be used to secure the switch 20 to the deadbolt latch sub-assembly 12. The switch 20 can have a connector 22 for connection with electronics for the deadbolt lock monitoring system, as described below with reference to FIGS. 3 and 4.

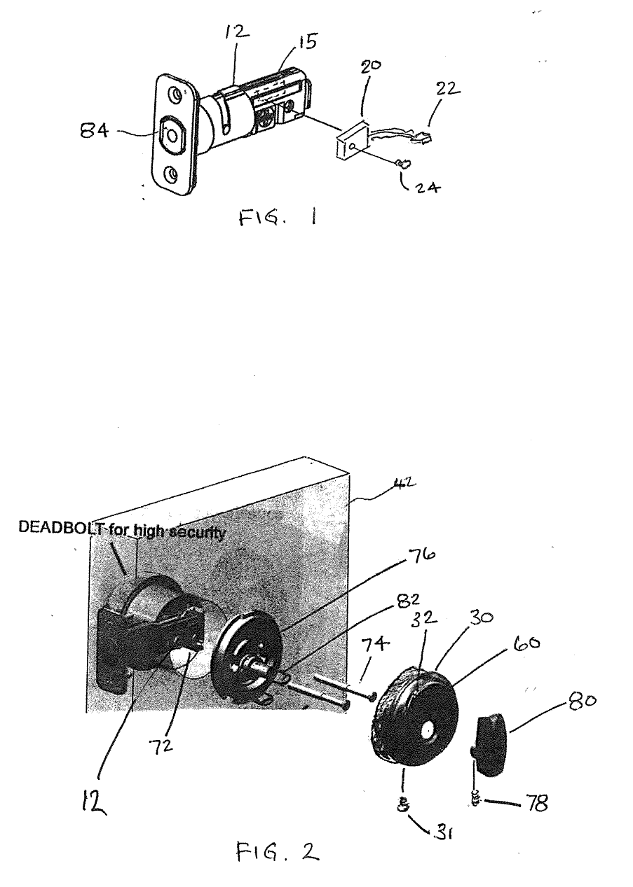

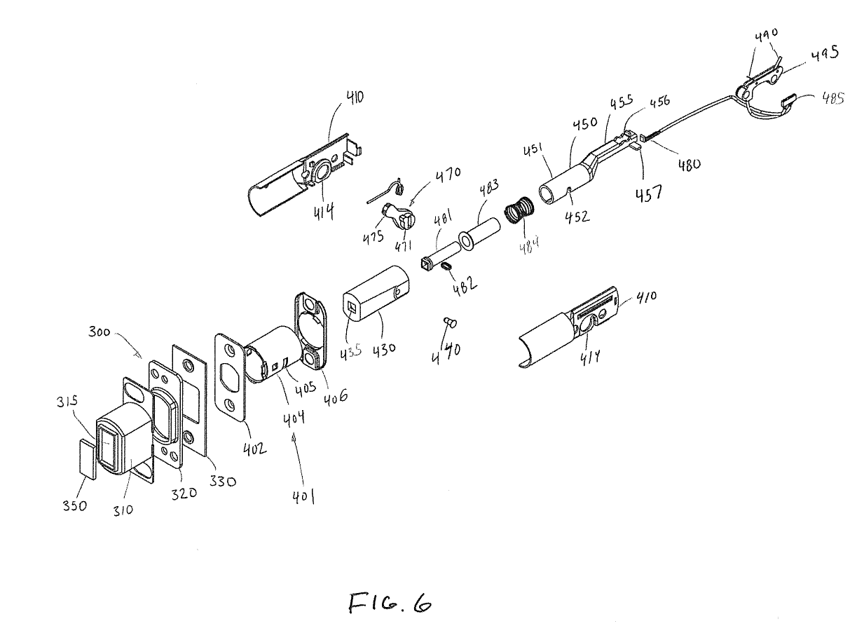

FIGS. 2 and 3 illustrate embodiments of an enclosure housing 30 for a lock-sensing module of the deadbolt lock monitoring system, as will be described below. The deadbolt latch assembly 12 can be configured to fit inside an opening of a door 42, as known to one of ordinary skill in the art. FIG. 2 illustrates an embodiment with a cylindrical enclosure housing 30. FIG. 3 illustrates an embodiment with a rectangular enclosure housing 30. Alternative geometric shapes for fitment or aesthetic reasons can also be contemplated. Additional detailed embodiments for the deadbolt lock monitoring system are provided below with reference to FIGS. 5-11B.

A key cylinder assembly portion of the deadbolt lock can be coupled to the deadbolt latch assembly 12 on a first, or an exterior, side of the door. The key cylinder assembly portion can have a key cylinder driver blade 72 coupled to the deadbolt latch assembly 12. The key cylinder driver blade 72 can be inserted and oriented to move the deadbolt to the extended and retracted position freely and without binding or excessive torque on a key used to actuate the deadbolt's movement.

The connector 22 from the switch 20 can be passed through an opening 23 in the mounting plate 76. The deadbolt assembly can be secured to the door with fasteners, such as concealed screws 74 through holes in a mounting plate 76, or by any other suitable fastening means. The factory pre-assembled interior enclosure housing 30 can be secured to the mounting plate 76 on the door 12 by one or more fasteners 31. A thumb turn 80 can be attached to a shaft 82 coupled to the deadbolt latch assembly 12, such as by a mechanical fastener 78. The shaft 82 can protrude through the enclosure housing 30 such that the thumb turn 80 is readily accessible.

FIG. 4 illustrates an exterior of an exemplary embodiment of the enclosure housing 30 of the deadbolt lock monitoring system, wherein the enclosure housing has a smooth surface without provision for physical actuation on one side of the door. The enclosure housing having a side without physical actuation can replace one of either the thumb turn 80 or the key cylinder assembly.

The enclosure housing 30, which can be either a generally round or rectangular configuration, can be positioned on one side of the deadbolt lock assembly. The enclosure housing 30 can have an RF window 32 to accommodate RF transmissions from an antenna, as described below. The enclosure housing can house the electronics necessary for communication between the switch 20 and an external electronic device, such as a phone, tablet, personal computer, or security system. Thus, the housing contains the electronics components comprising a lock-sensing module in accordance with embodiments of the disclosure. Specifically, for example, the lock-sensing module may include all, or at least one of, a central processing unit (CPU), computer readable storage, a wireless communication chip/module, such as Bluetooth® and related circuity to connect with a controller unit, such as the CPU or an external controller, an antenna 63 that can be contained within the enclosure housing 30 or extend out of the enclosure housing 30, a power source, and an indicator light 60. The power source can be hardwired or a user replaceable battery, such as an off the shelf Lithium-Ion battery 55 or like power source. In an exemplary embodiment, the replaceable battery can be a coin battery. The indicator light 60 can be an LED indicator light visible on the surface 67 of the enclosure housing 30. The indicator light 60 can comprise multiple colors to indicate the Locked or Unlocked condition, and/or alternatively the indicator light can be a single color, such as for indication of turned ON or OFF or to indicate a Locked or Unlocked condition. The indicator light may also flash in one or more selected frequencies to indicate a problem, and/or to confirm the pairing process between

In operation, a user can use an electronic device, such as a phone, tablet, personal computer, or security system to run program code or an application (“APP”) for interfacing with the deadbolt lock monitoring system. Multiple devices can be interfaced with the deadbolt lock monitoring system. Embodiments may provide for an intermediary electronic device, such as a security system, which can then relay the status of the deadbolt lock monitoring system to additional electronic devices. Initial pairing of the electronic device and the deadbolt lock monitoring system is described in further detail below. After the deadbolt assembly portion is installed, the user can use the APP on the electronic device to interface with the deadbolt lock monitoring system. For initial set up, there can be a reset button 70 provided on the enclosure housing 30 to initiate the pairing process. At least one of the APP of the electronic device or the indicator light 60 can provide guidance to the user through the pairing process. For example, the indicator light 60 can flash in a certain color and/or flash in a predetermined sequence to indicate when the lock is in “Pairing” mode, and when the Pairing is successfully accomplished.

When the deadbolt 84 is fully extended, which corresponds to a locked position of the deadbolt, the switch (sensor) 20 is triggered (activated). The triggered switch can then send a signal indicating a change of the internal status (Unlocked) of the lock to “Locked.” When the deadbolt's position is changed (retracted or partially or fully retracted), the switch 20 is no longer activated. When the switch is no longer triggered, it can then change the internal status of the lock to “Unlocked.” Therefore, whenever there is an internal status change, regardless of whether the status changed to “Locked” or “Unlocked,” a transmission of the new status can be broadcasted to all paired electronic devices. This can be done via the APP for all electronic devices within communication range of the deadbolt. This transmission can be configured to occur whenever the lock status has changed and regardless if any paired devices are within range. The LED indicator light 60 can either change colors, or illuminate (or un-illuminate) depending on the status of the lock.

At any time, when the user and a paired electronic device is within communication range of the lock, the user can open the APP on the electronic device, such as a smartphone or tablet, and query the lock of its status. Alternatively, if the lock is connected to a security system with an external connection, such as via the internet, the user may access the status from any location. The indicated status of the deadbolt's condition/position may only provide a notification of its current status to the paired device via the APP.

In some embodiments, the APP can allow for the user to use the electronic device to issue other commands to the lock other than inquiring about the lock's current status.

In the case where the deadbolt lock monitoring lock system uses a battery power source, the system can provide a battery state update. Whenever the battery state of charge falls to a predetermined level or threshold (e.g. starting at 100% and stepping down in either 5% or 10% increments), a notification of a “Battery Status,” indicating the status of the battery, will be transmitted whenever the status of the lock is changed or whenever the user queries the lock for its status. For instance, when the battery reaches the next battery level (in 5% or 10% increments), that is, whenever the status of the lock is changed or the user queries for the lock status, in addition to broadcasting the lock status, an updated notification of the battery status will also be transmitted to the paired devices via the APP.

In some embodiments, when the battery charge level is at predetermined minimum threshold (e.g., at 5% battery remaining), the LED indicator light 60 can either change to a different color and/or flash in a pre-determined sequence to indicate that the battery is low and needs replacing.

FIG. 5 illustrates an embodiment of a deadbolt lock monitoring system 10 mountable on a door. The deadbolt lock monitoring system 10 includes an inside thumb turn assembly 100 mountable on an inside face of the door, an outside cylinder assembly 200 mountable on the outside face of the door, a strike plate assembly 300 mountable on a door jamb/frame, and a latch assembly 400 mountable through an edge of the door.

The inside thumb turn assembly 100 includes an inside housing 110 with an RF window 115, a thumb-turn lever 120, a wireless communication chip/module 130 using Bluetooth® (e.g. Bluetooth® 5.0), related circuity with a microcontroller unit (MCU) or central processing unit (CPU) and computer readable storage 135, an antenna 140, a battery 145 (e.g., a lithium-ion coin cell battery or other user replaceable off-the-shelf battery) as a power source, a light emitting diode (LED) indicator light 150 visible on the surface of the inside housing 110, a reset button 155 accessible for actuation through a small aperture 112 located on the outer surface of the inside housing, and an inside housing connector 160 to connect circuitry within the inside housing 110 with the latch connector 485 of the latch assembly 400 as further discussed below. The computer readable storage can include storing program code configured to retrieve or receive information from inputs and transit information. Additional detail regarding the latch assembly 400 is provided below with respect to FIGS. 5-11B.

In some embodiments, the wireless communication chip/module 130 can be a Bluetooth® transmitter. Alternatively, other communication methods, such as Wi-Fi®, can be envisioned.

The LED light 150 can be in multiple colors to indicate locked and unlocked conditions. Alternatively, the LED light 150 can be a single color, turned either ON or OFF, to indicate the locked or unlocked condition. The LED light 150 may also flash either to indicate a problem or to confirm a pairing process.

A reset button 155 can be used in the initial pairing of the deadbolt lock monitoring system 10 to a remote wireless Bluetooth compatible electronic device, such as a smartphone, tablet, personal computer, security system, etc., or to restore the deadbolt lock monitoring system 10 to factory default conditions.

The outside cylinder assembly 200 can include an outside housing 210, a protection shield 220, an outside cylinder 240, and a tailpiece 230 coupled to the outside cylinder 240. The tailpiece 230 can extend through a cam (not shown) of the latch assembly and can engage the thumb-turn lever 120. The tailpiece 230 can rotate when the outside cylinder 240 is turned with a key or when the thumb-turn lever 120 is operated by a user. Rotation of the tailpiece 230 in one direction can rotate the cam of the latch assembly 400 to extend a deadbolt of the latch assembly 400, and rotation of the tailpiece 230 in an opposite direction can rotate the cam to retract the deadbolt, as explained in further detail below. The deadbolt of the latch assembly 400 can extend into the strike plate assembly 300 to secure the door in a closed position and in a locked state. The outside cylinder assembly 200 can first be attached to the mounting plate 190 of the inside thumb turn assembly 100.

The latch assembly 400 can extend through the edge of the door and is partially exposed by a hole extending through the inside and outside surface of the door. The protection shield 220, which may also be known as an anti-pry shield, extends at least partly into the hole to prevent a tool from access to the latch assembly 400. The outside housing 210 can fit over the protection shield 220. The protective shield may have an outer rim seated against or adjacent to the perimeter of the hole on the outside face of the door. A pair of fasteners can be inserted through the inside housing and threaded into the outside cylinder 240 to draw the outside cylinder assembly 200 and the inside thumb-turn assembly 100 together against the outside and inside faces of the door, respectively. More specifically, the outside cylinder 240 can urge the outside housing 210 towards the door to secure the protection shield 220 between the door and the outside housing 210 thereby covering or preventing access to the fasteners or the latch assembly 400. When assembled, the deadbolt can be retracted to an unlocked state and extended to a locked state by turning the thumb-turn lever 120 inside the door or by turning a key (not shown) inserted into the outside cylinder 240 from outside the door.

The RF window 115 of the inside housing 110 can accommodate RF transmission from the antenna 140. The shape of the inside housing 110 can be generally cylindrical, rectangular, or any other suitable shape. The inside cavity of the inside housing 110 is large enough to house at least one of the wireless communication chip/module 130, related circuity to connect with the CPU 135, the antenna 140, the battery 145, the LED indicator light 150, the reset button 155 accessible for actuation through a small aperture located on the outer surface of the inside housing 110, and the inside housing connector 160.

FIG. 6 illustrates an exploded view of components of the deadbolt lock monitoring system. The strike plate assembly 300 can extend into the door jamb and can include a dust box 310, a reinforcement plate 320, and a strike plate 330. The strike plate 330, when installed to the door jamb, can be generally flush with the surface of the door jamb. The reinforced plate 320 can typically be much stronger than the strike plate 330. Generally, two very long screws are passed through openings on opposite sides of the reinforced plate 320 and the dust box 310, and into a wooden stud outside the door frame to make it more difficult for a person to kick the door open. Shorter screws may not extend deep enough into the stud to prevent the shorter screws from being ripped away from the door jamb. Regular short fasteners can then be used to attach the strike plate to the door jamb against the reinforcement plate 320. Other suitable fastening elements or device may suggest themselves for the above-described purposes to those skilled in the pertinent arts.

A channel 301 can extend through an opening of the strike plate 330, an opening of the reinforcement plate 320, and an opening of the dust box 310 into a cavity 315 of the dust box 310 to allow the deadbolt of the latch assembly 400 to fully extend into the dust box 310. Preferably, the deadbolt, when fully extended, should loosely fit through the channel 301 through the strike plate 330, the reinforcement plate 320, and the dust box 310.

A magnet 350 may advantageously be attached to the inside or outside a bottom opposite the opening of the dust box 310 to trigger a magnetometer or magnetic sensor in the latch assembly 400. As discussed below, the magnetometer or magnetic sensor, if present, can be located within the deadbolt. However, the magnetometer or magnetic sensor may also be located inside the inside housing 110 or form a part of the inside thumb-turn assembly 100, such as the lever.

The deadbolt can be close to or in contact with the magnet 350 only when the deadbolt is fully extended, so that the magnetic sensor within the deadbolt can detect the presence of the magnet 350 when the deadbolt is fully extended. If no dust box 310 is used, the dust box 310 does not have a bottom, or the design dictates the magnet 350 be placed elsewhere, such as a side of the dust box 310, then the magnet 350 can be positioned anywhere adjacent the latching assembly 400, so long as the magnetic sensor can detect the magnet when the deadbolt is fully extended and the door is closed, or simply when the door is closed.

The latch assembly 400 can include a latch housing 410, a faceplate subassembly 401 comprising an adjustment casing 404 having a helical slot 405 coupled to the housing 410, a faceplate adapter 406 fixed to the adjustment casing 404, and a faceplate 402 attached to the faceplate adapter, a deadbolt 430 and a driver 450 coupled together and slidable within the latch housing 410, and a latch cam 470 for moving the deadbolt 430 relative to the latch housing 410 between an unlocked position and a locked position by rotation of the latch cam 470.

The driver 450 can include a hollow first (cylindrical) portion 451 and a second (longitudinal) portion 455 extending away the cylindrical portion 451. A channel 452 may extend in a helical fashion a half revolution around the cylindrical portion for adjusting the position of the deadbolt relative to the driver as discussed further below. This can allow the latch assembly 400 to be fitted on doors having a different backset, which is the distance between the edge of the door and the center of the lock hole on the door. The channel 452 may also be a through-hole.

A slot 456 may be defined in the longitudinal portion 455 of the driver 450 for receiving a tail of the latch cam 470 to drive the deadbolt 430 between the locked position and the unlocked position. A driver guide 457 extending from the driver 450 can be slidably captured in a driver guide slot 412 of the housing 410 to ensure the driver 450 moves in a linear direction. The driver guide 457 may also activate a switch in the fully extended and/or fully retracted position detailed below.

FIGS. 6-8 illustrate the various components of an embodiment of the deadbolt assembly 400. The latch cam 470 includes a cylindrical body 471 and a tail 475 extending from the cylindrical body 471 into the slot 124. The cylindrical body 471 can rotate inside a pair of circular holes 414 of the latch housing 410. The holes 414 are aligned along a rotation axis. The cylindrical body 471 has a slot through which the tailpiece 230 of the outside cylinder assembly 200 extends. The rotation of the thumb-turn lever 120 or rotation of a key inserted in the outside cylinder 240 causes the tailpiece 230 to rotate, which then causes the latch cam 470 to rotate. The latch cam 470 rotates the tail 475 towards the direction of the deadbolt 430 until it presses against an edge of the slot 456 in the driver 450 to move the driver 450 to extend the deadbolt 430. The latch cam can be rotated until the deadbolt is fully extended to a locking state. Rotation of the latch cam to rotate the tail in a direction away from the deadbolt causes the tail to press against an opposite edge of the slot in the driver to urge the driver to retract the deadbolt. Movement of the driver 450 also moves the driver guide 457. In the locked state with the deadbolt fully extended, the driver guide 457 can contact a first switch. In some embodiments, in the unlocked state with the deadbolt fully retracted, the driver guide 457 can contact a second switch.

The deadbolt 430 has an internal cavity 432 with an opening 431 at a first end and a through hole 435 at an opposite second end. The cylindrical portion 451 of the driver 450 extends axially through the opening 431 and into the internal cavity 432. A securing pin 440 extends laterally through a sidewall of the deadbolt 430 and directly into the channel 452 of the driver 450 to couple the deadbolt 430 to the driver 450. With the pin 440 secured to the deadbolt 430, the deadbolt 430 can rotate spirally about the driver 450 as the pin 440 slides inside the channel 452 to adjust the backset. At the same time, the faceplate subassembly 401 rotates spirally about the latch housing 410 guided by a protrusion on a surface of the latch housing 410 inside the helical slot 405. Thus, the face of the deadbolt 430 is maintained at the same position relative to the faceplate 402 regardless of the desired backset.

A proximity sensor 480, such as magnetometer or a magnetic (e.g., Hall effect) sensor, may be fixed within the through hole of the deadbolt and flush or slightly recessed from a surface of the deadbolt. If a magnetic sensor is used, it is configured to detect the presence of a magnetic field, and it can be combined with other components to form a Hall effect switch. For example, when the magnetic flux from the magnetic field passing through the magnetic sensor 480 exceeds a preset value, the output switches quickly between an “OFF” condition to an “ON” condition without any contact bounce. Built-in hysteresis can eliminate any oscillation of the output signal as the magnetic sensor moves in and out of the magnetic field. If the deadbolt 430 is in the fully extended position and is engaged in the strike plate assembly 300, the magnet located at or near the first end of the magnetic sensor 480 will trigger the Hall effect switch to indicate that the door is closed shut and locked. If the deadbolt is in the locked position but not engaged in the strike plate assembly 300, the Hall effect switch would remain in the “OFF” condition, indicating the door is not closed. Simply, if the magnetic sensor encounters a magnetic field, a closed door is detected, and if no magnetic field is encountered, an open door is detected. The magnetic sensor 480 may be protected by a protective housing 481, which, in turn, may be surrounded by an anti-cut roller 483 to prevent hacking the deadbolt 430. When someone uses a hack saw to cut the deadbolt, eventually it will reach the roller 483, usually made of steel, whereby the roller will spin, so as to impede hacking further. A spring 484 can bias the roller 483 away from the driver 450 in order to maintain its position to prevent hacking.

A wired connector 485 of the magnetic sensor 480 can be routed from inside the internal cavity of the deadbolt 430 out the opening and through the cylindrical portion 451 of the driver 450 and the latch housing 410. The wired connector can include a wire to a power supply (e.g., +5 VDC), a ground return, and a signal wire. The signals through the signal wire can be an output voltage proportional (e.g., half) to the voltage between the power supply and ground. A grommet 482 can prevent wires of the magnetic sensor 480 from damage against the latch housing 410 as the deadbolt 430 retracts and extends.

Instead of using a magnetic sensor as a proximity sensor, as described above, other types of proximity sensors could be used, such as a contact sensor, a capacitive sensor, or an optical sensor. The modifications needed to accommodate these alternative proximity sensors will readily suggest themselves to those skilled in the pertinent arts.

The battery 145 can supply power to the at least one contact switch 490, the proximity sensor 480, the light 150, the CPU 135, and the other electrical components. The output signals from the contact switches 490 and the proximity sensor 480 can be processed in the CPU to determine and control the appropriate color of the light 150 as explained below.

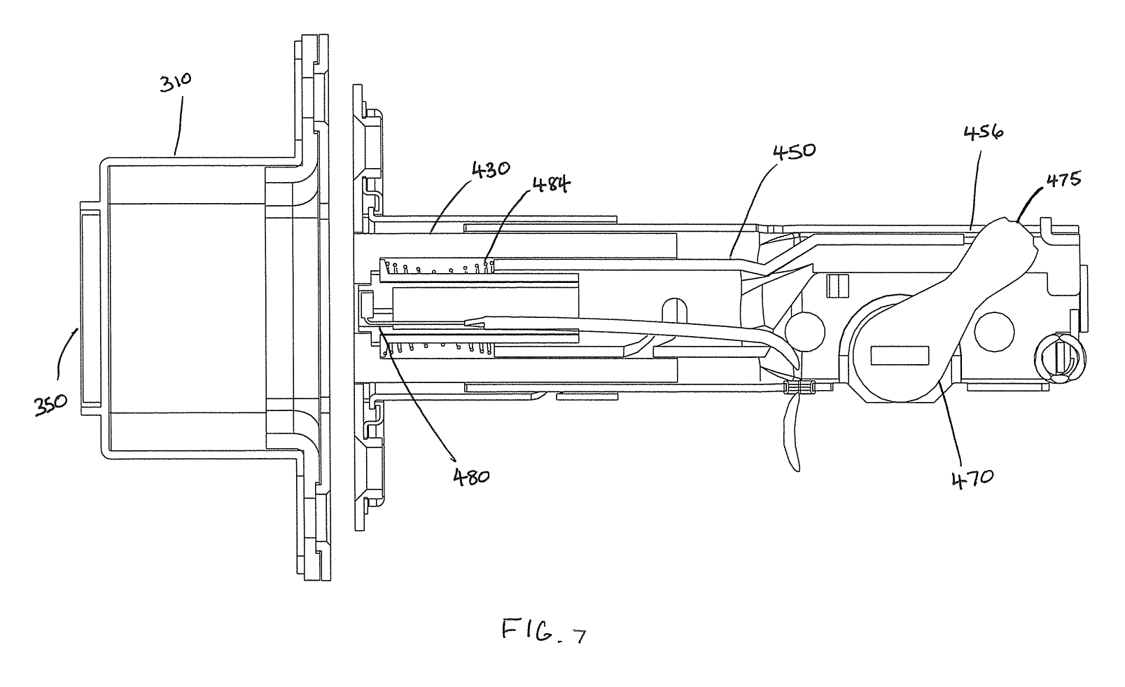

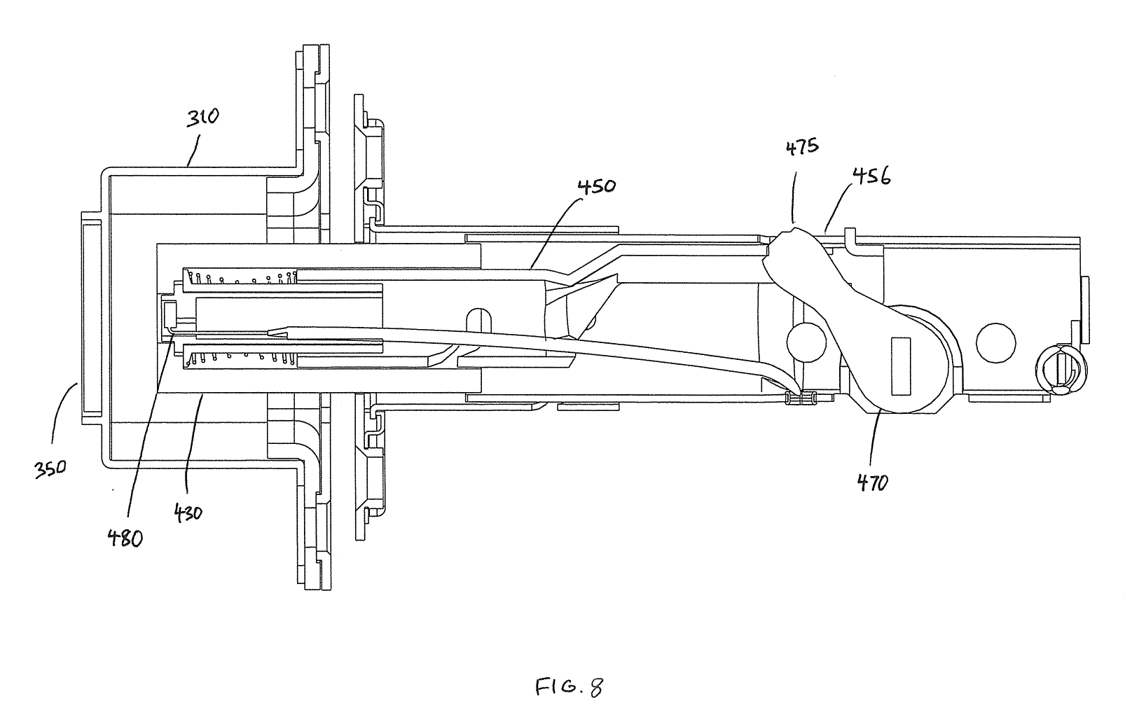

FIGS. 7 and 8 illustrate sectional views of the latch assembly 400, in which the proximity sensor is a magnetic sensor 480, as described above. FIG. 7 illustrates a view in an unlocked, or retracted, state, and FIG. 8 illustrates a view in a locked, or extended, state. In FIG. 7, the deadbolt is in the fully retracted state, such that the sensor 480 is spaced apart from the magnet 350. In this state, the magnetic sensor 480 is in a state that does not meet the predetermined threshold value for indication of a locked state. In FIG. 8, the deadbolt is in the fully extended state, such that the magnetic sensor 480 is at a closest position to the magnet 350. In this state, the magnet located at or near the first end of the magnetic sensor 480 will provide a sufficient magnetic reading by the magnetic sensor to meet the predetermined threshold value to indicate that the door is closed shut and locked.

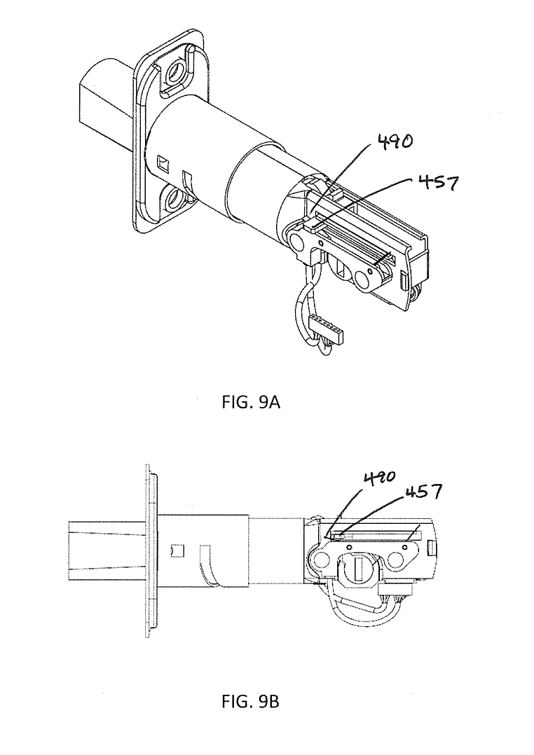

FIGS. 9A and 9B illustrate perspective and plan views of the latch assembly 400 in a fully extended state. As shown in FIGS. 5-10B, at least one contact switch 490, which acts as a sensor when activated, can be used in combination with a Hall effect switch (as described above) to reduce false readings and to provide additional information. The contact switch 490 can be positioned adjacent to or within the housing 410, such that the driver guide 457, which is slidably received in the driver guide slot 412 of the latch housing 410, can activate the contact switch 490 when the deadbolt 430 is in the fully extended position. As shown, the contact switch 490 can be mounted on a switch support 495, which is attached to the housing 410. A connector for the contact switch 490 can be shared with the wired connector 485 for the magnetic sensor. The wired connector 485 can be passed through the mounting plate 190 for connection with the inside housing connector 160.

TABLE 1

| | | Hall | |
|---|---|---|---|
| | contact | effect | |
| Status | switch | switch | Door Secured? |
| 1 | ON | OFF | No, door ajar |
| 2 | OFF | OFF | No, deadbolt not extended |
| 3 | OFF | ON | No, deadbolt not extended and error |
| | | | because this combination is not possible |
| 4 | ON | ON | Yes, deadbolt extended and door closed |

As shown in Table 1, the combination of the contact switch 490 and the Hall effect switch can sufficiently determine the status of the door. Only when the contact switch 20 and the Hall effect switch are activated or switched to the “ON” condition, is the door fully secured with the deadbolt 110 fully extended inside the strike plate assembly 300. To conserve power, the deadbolt monitoring system 10 can be operated so that power is supplied to the Hall effect switch after the contact switch 20 is activated. To detect if the door is closed with the door remaining in an unlocked state, a “check” can be performed by the deadbolt 430 being temporarily thrown to the locked position and quickly withdrawn back to the unlocked position to determine if the Hall effect switch registers the magnet in the strike plate assembly.

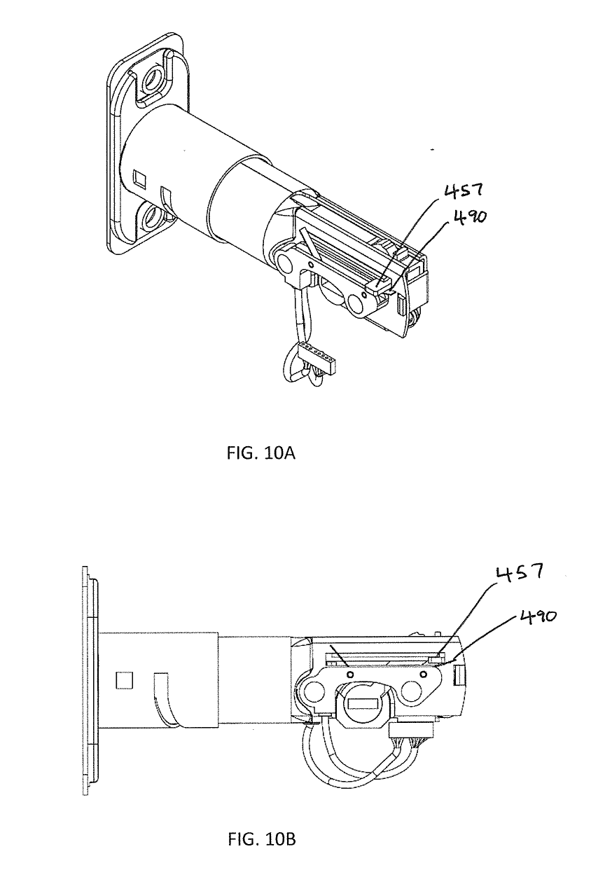

FIGS. 10A and 10B illustrate perspective and plan views of the latch assembly 400 in a fully retracted state. In embodiments, a second contact switch 490 can be provided for indication of a fully retracted state. As shown in FIGS. 10A and 10B, the second contact switch 490 can be located adjacent to or within the housing 410, or supported by the switch support 495 such that the driver guide 457 can activate the first contact switch 490 when the deadbolt 430 is in the fully retracted position. Thus, if neither of the contact switches 490 is activated, then the deadbolt 430 is in an intermediary location, neither fully retracted nor fully extended. In this situation, an error is determined. Moreover, the time it takes to change from one position to the other may indicate that the battery is low, or that a motor, if present, is failing, or that there is undesirable friction in the deadbolt, or that other electrical or mechanical problems may be present.

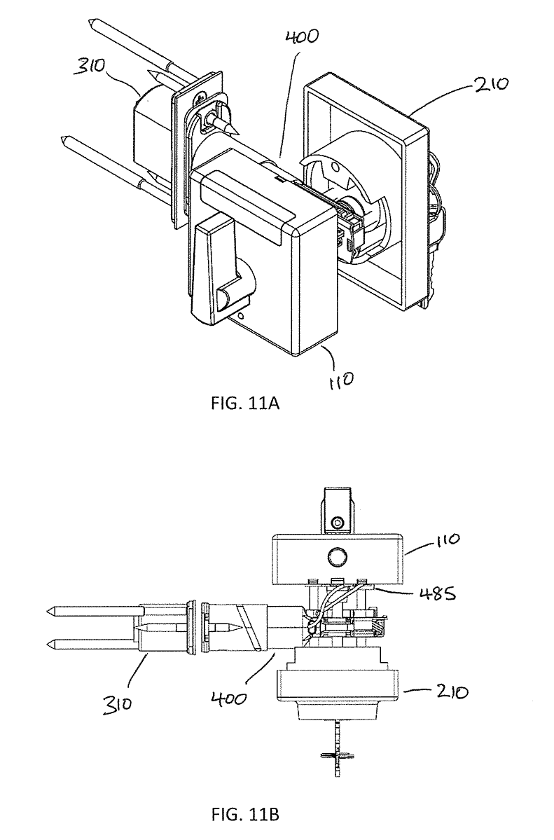

FIGS. 11A and 11B illustrate perspective and plan views of the deadbolt lock monitoring system in an assembled state.

In exemplary embodiments, the deadbolt lock monitoring lock system can be interfaced with a user's electronic device through program code, or an application (“APP”). Before, during, or after installation of the deadbolt lock monitoring system to the door, the initial pairing set up can begin with the user first downloading the APP to the remote wireless communication electronic device or devices, e.g. smartphone, tablet, personal computer, or security system. The APP may advantageously provide a simple user interface or a screen display showing the status (Locked or Unlocked) of one or more deadbolt locks as defined/described by the user during the initial set-up of the APP. The APP display can also show the Charge status of the battery 145 for each deadbolt that has been previously paired with the smartphone/tablet and that is within wireless connectivity range.

The APP can be program code configured to access a connection with the deadbolt lock monitoring system. The APP can then either automatically receive information from the deadbolt lock monitoring system, or send a query to retrieve the information. The APP can then display the information through the user interface of the electronic device.

To assemble the deadbolt monitoring lock system, an installer can install the key cylinder assembly portion of the deadbolt lock on the exterior side of the door. The next step is to confirm the tailpiece 230 is properly inserted and oriented to move the deadbolt 430 between the extended (locked) and retracted (unlocked) positions freely and without binding or excessive torque on the key to actuate the deadbolt's movement. Next, the contact switch(es) 490 may be positioned and secured to the support bracket 495. One or more fasteners may be used to ensure each of the switches 490 is securely affixed to the latch housing 410.

The next step is to pass the first connector 485 from the contact switch 490 and the sensor 480 through an opening in a mounting plate 190, and install fasteners (e.g., concealed screws) through the holes in mounting plate 190 to secure the outside cylinder assembly 200 to the door.

The inside thumb turn assembly 100, having been previously paired to the remote wireless device(s), is next secured to the mounting plate 190 on the door by snapping onto the mounting plate 190 or by one or more fasteners (not shown).

The next step is to attach the thumb-turn lever 120 to a shaft protruding through the inside housing 110, if necessary.

After the deadbolt assembly portion is installed, the user can then launch the APP on the remote wireless device and then press the reset button in the enclosure housing to initiate the paring process. The APP will then guide the user through the pairing process.

The LED indicator light may be operable either to flash in a certain color and/or flash in a predetermined sequence to indicate when the lock is in a “pairing” mode, and when the pairing is successfully accomplished.

In operation, a user can use an electronic device, such as a phone, tablet, personal computer, or security system to run an application for interfacing with the deadbolt lock monitoring system. Multiple devices can be interfaced with the system. Embodiments may provide for an intermediary electronic device, such as a security system, which can then relay the status of the deadbolt lock monitoring system to additional electronic devices. Initial pairing of the electronic device and the deadbolt lock monitoring system is described in further detail below. After the deadbolt assembly portion is installed, the user can use the application on the electronic device to interface with the deadbolt lock monitoring system. For initial set up, there can be a reset button 155 provided with the housing 110 to initiate the pairing process. At least one of the application of the electronic device or the indicator light 150 can provide guidance to the user through the pairing process. For example, the indicator light 150, can flash in a certain color and/or flash in a predetermined sequence to indicate when the lock is in “Pairing” mode and when the Pairing is successfully accomplished.

When the deadbolt 430 is fully extended, which corresponds to a locked position of the deadbolt, the sensor 480 and the switch 490 are triggered (activated). The triggered switch can then send a signal indicating a change of the internal status (Unlocked) of the lock to “Locked.” When the deadbolt's position is changed (retracted or partially or fully retracted), the sensor 480 and the switch 490 are no longer activated. When the sensor and the switch are no longer triggered, the internal status of the lock is changed to “Unlocked.” Therefore, whenever there is an internal status change, regardless of whether the status changed to “Locked” or “Unlocked,” a transmission of the new status can broadcast to all paired electronic devices. This can be done via the application for all electronic devices within communication range of the deadbolt. This transmission can be configured to occur whenever the lock status has changed and regardless if any paired devices are within range. The LED indicator light 150 can either change colors, or illuminate (or un-illuminate) depending on the status of the lock.

At any time, when the user and a paired electronic device are within communication range of the lock, the user can open the application on the electronic device, such as a smartphone or tablet, and query the lock of its status. Alternatively, if the lock is connected to a security system with an external connection, such as via the internet, the user may access the status from any location. As mentioned above, the status of the deadbolt's condition/position may only provide a notification of its current status to the paired device via the application, and the application may optionally be configured to allow the user to use the electronic device to issue commands to the lock other than inquiring about the lock's current status.

In the case where the deadbolt monitoring lock system uses a battery power source, the system can provide a battery state update. Whenever the battery state of change falls to a predetermined level or threshold (e.g. starting at 100% and stepping down in either 5% or 10% increments), a notification of a “Battery Status,” indicating the status of the battery, will be transmitted whenever the status of the lock is changed or whenever the user query the lock for its status. So in other words, when the battery reaches the next battery level (in 5% or 10% increments), that is, whenever the status of the lock is changed or the user query for the lock status, in addition to broadcasting the lock status, an updated notification of the battery status will also be transmitted to the paired devices via the application.

In some embodiments, when the battery charge level is at predetermined minimum threshold (e.g. at 5% battery remaining), the LED indicator light 150 can either change to a different color and/or flash in a pre-determined pattern to indicate that the battery is low and needs replacing.

Embodiments of the disclosure can thus provide a method of remotely determining the locked or unlocked status of a lock latch. The method can include receiving information related to the position of the lock latch from a position detector, determining whether the lock latch is in a locked or an unlocked state from the information, and transmitting the determined locked or unlocked state through a transmitter to a remote electronic device. The method can include, wherein the information from the position detector comprises a position signal having a first value when the detected position of the lock latch is in the unlocked state and a second value when the detected position of the lock latch is in the locked state.

Although limited embodiments of the deadbolt monitoring locking system, its components, and related methods have been specifically described and illustrated herein, many modifications and variations will be apparent to those skilled in the art. Furthermore, it is understood and contemplated that features specifically discussed for one embodiment may be adopted for inclusion with another embodiment when appropriate. Accordingly, it is to be understood that the deadbolt monitoring locking system, its components, and related methods constructed according to principles of the disclosed devices and methods may be embodied other than as specifically described herein. The disclosure is also defined in the following claims.

1-20. (canceled)

21. An electronic lock monitoring apparatus, comprising:
a deadbolt assembly configured for mounting to a door and operable between a first position and a second position;
a position detector configured to detect whether the deadbolt assembly is in the first position or in the second position, and to generate a position signal indicative of the deadbolt assembly position; and
a transmitter responsive to the position signal and operable to transmit wirelessly the position of the deadbolt assembly as detected by the position detector.

22. The electronic lock monitoring apparatus of claim 21, wherein the position detector comprises at least one of a contact switch and a proximity sensor.

23. The electronic lock monitoring apparatus of claim 22, wherein the proximity sensor is selected from the group consisting of at least one of a magnetic sensor, an optical sensor, a capacitive sensor, a Hall effect sensor, and an ultrasonic sensor.

24. The electronic lock monitoring apparatus of claim 21, wherein the position detector comprises:
a first contact switch generating a first position signal when the deadbolt assembly is in the first position; and
a second contact switch generating a second position signal when the deadbolt assembly is in the second position;
wherein the transmitter is responsive to the first and second position signals.

25. The electronic lock monitoring apparatus of claim 21, further comprising:
a processor; and
a computer readable storage medium in data communication with the processor, the storage medium comprising program code to be executed by the processor, the program code comprising computer-implementable instructions to:
receive the position signal from the position detector;
determine whether the position signal has a first value corresponding to the first position or a second value corresponding to the second position; and
enable the transmitter to transmit a wireless signal indicative of the value of the position signal.

26. The electronic lock monitoring apparatus of claim 23, wherein the position detector further comprising a contact switch.

27. The electronic lock monitoring apparatus of claim 26, wherein the first position is an unlocked position and the second position is a locked position, and wherein the contact switch is actuated by the deadbolt assembly when the deadbolt assembly is in the locked position.

28. The electronic lock monitoring apparatus of claim 27, further comprising:
a Hall effect sensor; and
a power supply;
wherein the contact switch is configured to connect the Hall effect sensor to the power supply when the contact switch is actuated.

29. An electronic monitoring lock apparatus, comprising:
a deadbolt assembly configured for mounting to a door, the deadbolt assembly including a latch movable between an unlocked position and a locked position;
a sensor configured to generate a position signal having a first value when the latch is in the locked position and a second value when the latch is in the unlocked position; and
a transmitter responsive to the position signal for transmitting a wireless signal indicative of the value of the position signal.

30. The electronic monitoring lock apparatus of claim 29, wherein the sensor includes a contact switch.

31. The electronic monitoring lock apparatus of claim 30, wherein the contact switch is configured to be actuated when the latch is in the locked position.

32. The electronic lock monitoring apparatus of claim 31, wherein the contact switch is a first contact switch, the apparatus further comprising a second contact switch configured to be actuated when the latch is in the unlocked position.

33. The electronic monitoring lock apparatus of claim 33, further comprising:
a processor; and
a computer readable storage medium comprising program code to be executed by the processor, the program code comprising computer-implementable instructions to:
receive the position signal from the sensor;
determine from the position signal whether the latch is in the locked position or the unlocked position; and
output the determined latch position to the transmitter.

34. The electronic lock monitoring apparatus of claim 29, wherein the deadbolt assembly includes a magnet, and wherein the sensor comprises a Hall effect sensor configured to interact with the magnet to determine whether the latch in the locked position or the unlocked position.

35. The electronic lock monitoring apparatus of claim 29, wherein the wireless signal is configured to communicate with a remote receiver selected from the group consisting of one or more of a smartphone, tablet, personal computer, and a security system.

36. The electronic lock monitoring assembly of claim 34, wherein the contact switch is configured to connect the Hall effect sensor to a power supply when the contact switch is actuated.

37. A method of remotely determining the locked or unlocked status of a lock latch, the method comprising:
receiving position information related to the position of the lock latch from a position detector;
determining whether the lock latch is in a locked state or an unlocked state from the position information; and
wireles sly transmitting a signal indicative of the determined locked or unlocked state to a remote electronic device.

38. The method of claim 37, wherein the position information comprises a position signal having a predetermined value when the detected position of the lock latch is in the locked state.

39. The method of claim 38, wherein the position detector is powered by a battery, the method further comprising:
receiving battery level information; and
transmitting the battery level information wirelessly to the remote electronic device.
